(19) United States
(12) Patent Application Publication
(10) Pub. No.: US 2026/0214749 A1
(43) Pub. Date: Jul. 23, 2026

(54) DETERMINING PROBABILITY OF SUCCESSFUL PUSH-TO-TALK CALL CONNECTION

(71) Applicant: MOTOROLA SOLUTIONS, INC., Chicago, IL (US)

(72) Inventors: Amit Kumar, Ranchi (IN); Harisha Negalaguli, McKinney, TX (US); Shekhar Padasalagi, Bengaluru (IN); Manjunatha Rajappa, Bangalore (IN)

(21) Appl. No.: 19/033,082

(22) Filed: Jan. 21, 2025

(51) Int. Cl. H04W 76/45; H04L 41/16; H04W 60/00; H04W 76/20

(52) U.S. Cl. CPC H04W 76/45; H04L 41/16; H04W 60/00; H04W 76/20

(57) ABSTRACT

Examples provide a server configured to communicatively connect to a plurality of push-to-talk (PTT) devices that communicate with one another over a communication network. The server includes an electronic processor configured to receive, from a second PTT device included in a list of contacts stored by a first PTT device, a disconnection status indicating a disconnection of the second PTT device from the communication network, and after receiving the disconnection status, receives a re-registration status indicating a connection of the second PTT device to the communication network. The electronic processor determines an online status of the second PTT device, and determines a probability of the first PTT device establishing a successful PTT call connection with the second PTT device based on the re-registration status, the online status, the disconnection status, and a time difference between a re-registration timestamp and a disconnection timestamp of the second PTT device.

### BACKGROUND

Examples described herein relate to push-to-talk (PTT) communication systems, and more particular to determining the probability of successful call connections between PTT devices.

### BRIEF DESCRIPTION OF THE DRAWINGS

FIG. 1 illustrates a radio communication system, according to some examples.

FIG. 2 schematically illustrates a device, according to some examples.

FIG. 3 schematically illustrates a device, according to some examples.

FIG. 4 schematically illustrates a server, according to some examples.

FIG. 5 is a workflow for registering a PTT device to a server, according to some examples.

FIG. 6 is a flowchart of a method for determining the probability of a successful push-to-talk call connection, according to some examples.

FIG. 7 is a flowchart of a method for displaying a probability of a successful push-to-talk call connection, according to some examples.

FIG. 8 illustrates a user interface displaying a probability of a successful push-to-talk call connection, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Push-to-talk (PTT) communication systems allow users to instantly connect with other users or groups at the push of a button. These systems are widely used in mission-critical applications such as public safety, emergency response, and military operations where rapid and reliable communication is essential. PTT systems typically operate over dedicated networks (e.g., land mobile radio (LMR) networks) or cellular infrastructure to provide near-instantaneous voice communication between users.

Mission Critical Push-to-Talk (MCPTT) is a standardized communication protocol designed to meet the stringent requirements of public safety and emergency response organizations. The MCPTT standard may include specifications for group call, private call, and emergency call functionalities, as well as priority and preemption capabilities to ensure critical communications are prioritized during high-demand situations. MCPTT systems may operate using long-term evolution (LTE) and 5G networks to provide wide-area coverage and high-speed data transmission. These systems may offer features such as end-to-end encryption, location services, and multimedia messaging to support comprehensive situational awareness. In some implementations, MCPTT can integrate with existing LMR systems, allowing for interoperability between legacy and modern communication infrastructures.

In modern PTT systems, such as MCPTT systems, users often have contact lists stored on their devices showing the availability status of other users. This presence information helps users determine which contacts are currently online and available for communication. However, the accuracy and reliability of this presence information can be challenging to maintain in dynamic network environments where users may frequently connect and disconnect.

Existing PTT systems may struggle to provide users with up-to-date and reliable information about the true availability of their contacts. Network connectivity issues, delayed status updates, or inconsistencies between the reported and actual status of a user can lead to failed communication attempts and operational inefficiencies. This is particularly problematic in mission-critical scenarios where every second counts and failed communication attempts can have serious consequences.

Additionally, current PTT systems typically provide binary online/offline status indicators that do not capture the nuances of a user's actual availability. A contact may appear as “online” but may have unstable connectivity or be in an area with poor network coverage, leading to unsuccessful call attempts despite the positive status indication.

There is a need for improved methods and systems to provide PTT users with more accurate and informative availability information for their contacts. Enhanced presence data could help users make more informed decisions about when and how to initiate communication, potentially improving operational efficiency and reducing failed call attempts in critical situations. One example provides a server configured to communicatively connect to a plurality of push-to-talk (PTT) devices that communicate with one another over a communication network. The server includes an electronic processor configured to: receive, from a first PTT device, a list of contacts stored by a first PTT device, receive, from a second PTT device that is included in the list of contacts stored by the first PTT device, a disconnection status of the second PTT device, the disconnection status indicating a disconnection of the second PTT device from the communication network and including a disconnection timestamp, receive, from the second PTT device after receiving the disconnection status, a re-registration status of the second PTT device with the server, wherein the re-registration status indicates a connection of the second PTT device to the communication network and includes a re-registration timestamp, determine an online status of the second PTT device based on the re-registration timestamp, determine a time difference between the re-registration timestamp and the disconnection timestamp, determine a probability of the first PTT device establishing a successful PTT call connection with the second PTT device based on the re-registration status of the second PTT device, the online status of the second PTT device, the disconnection status of the second PTT device, and the time difference between the re-registration timestamp and the disconnection timestamp, and transmit the probability to the first PTT device, wherein reception of the probability by the first PTT device causes a user interface of the first PTT device to display an indication of the probability.

In some aspects, the electronic processor is configured to transmit the probability to the first PTT device in response to receiving an indication that the first PTT device has initiated a PTT call to the second PTT device.

In some aspects, the electronic processor periodically transmits the probability to the first PTT device.

In some aspects, the electronic processor transmits the probability to the first PTT device in response to receiving a request from the first PTT device.

In some aspects, the electronic processor is configured to determine the probability according to a logistical regression algorithm model using a sigmoid function.

In some aspects, the electronic processor is further configured to: train a machine learning model using historical data sets corresponding to re-registration statuses, online statuses, disconnection statuses, and time differences for the second PTT device, wherein the probability corresponds to a confidence level output by the machine learning model.

In some aspects, the machine learning model is a generative AI model that outputs the confidence level based on a maximum likelihood estimation of the logistical regression algorithm model.

In some aspects, the historical data sets include a tally of re-registrations and disconnections of the second PTT device.

In some aspects, the electronic processor is further configured to, for each respective contact included in the list of contacts: determine a respective probability of establishing a successful PTT call connection from the first PTT device to the respective contact based on a re-registration status of the respective contact, an online status of the respective contact, a disconnection status of the respective contact, and a time difference between a disconnection timestamp and re-registration timestamp of the respective contact, and transmit the respective probability to the first PTT device

In some aspects, the electronic processor is further configured to in response to the probability being below a threshold, transmit a command to the first PTT device to temporarily block initiation of a PTT call to the second PTT device by the first PTT device.

In some aspects, the plurality of PTT devices is a plurality of mission critical PTT (MCPTT) devices and the communication network is a MCPTT network.

Another example provides a push-to-talk (PTT) system including: a first PTT device including a user interface, a memory storing a list of contacts, and a device electronic processor; and a server including a server electronic processor configured to receive, from a second PTT device that is included in the list of contacts, a disconnection status of the second PTT device, the disconnection status indicating a disconnection of the second PTT device from a communication network and including a disconnection timestamp, receive, from the second PTT device, a re-registration status of the second PTT device with the server, wherein the re-registration status indicates a connection of the second PTT device to the communication network and includes a re-registration timestamp, determine an online status of the second PTT device based on the re-registration timestamp, determine a time difference between the re-registration timestamp and the disconnection timestamp, determine a probability of the first PTT device establishing a successful PTT call connection with the second PTT device based on the re-registration status of the second PTT device, the online status of the second PTT device, the disconnection status of the second PTT device, and the time difference between the re-registration timestamp and the disconnection timestamp, and transmit the probability to the first PTT device; wherein the device electronic processor is configured to in response to receiving the probability, display an indication of the probability on the user interface.

In some aspects, the device electronic processor is further configured to display, on the user interface, an indication of the online status of the second PTT device adjacent to the indication of the probability.

In some aspects, the device electronic processor is configured to display the indication of the probability as a percentage.

In some aspects, the device electronic processor is further configured to receive the online status of the second PTT device, and in response to the online status of the second PTT device indicating that the second PTT device is not online, refrain from displaying the indication of probability.

In some aspects, the device electronic processor is further configured to in response to determining that the probability is below a threshold, temporarily block initiation of a PTT call to the second PTT device.

In some aspects, the server electronic processor is configured to determine the probability according to a logistical regression algorithm model using a sigmoid function.

In some aspects, the server electronic processor is further configured to: train a machine learning model using historical data sets corresponding to re-registration statuses, online statuses, disconnection statuses, and time differences for the second PTT device, wherein the probability corresponds to a confidence level output by the machine learning model.

In some aspects, the machine learning model is a generative AI model that outputs the confidence level based on a maximum likelihood estimation of the logistical regression algorithm model.

Another example provides a method for determining a probability of successful establishment of a push-to-talk (PTT) call connection between a call-originating PTT device and a target PTT device, the method comprising: receiving, from the call-originating PTT device, a list of contacts stored by the call-originating PTT device; receiving, from the target PTT device that is included in the list of contacts stored by the call-originating PTT device, a disconnection status of the target PTT device, the disconnection status indicating a disconnection of the target PTT device from a communication network and including a disconnection timestamp; receiving, from the target PTT device after receiving the disconnection status, a re-registration status of the target PTT device, wherein the re-registration status indicates a connection of the target PTT device to the communication network and includes a re-registration timestamp; determining an online status of the target PTT device based on the re-registration timestamp; determining a time difference between the re-registration timestamp and the disconnection timestamp; determining a probability of the call-originating PTT device establishing a successful PTT call connection with the target PTT device based on the re-registration status of the target PTT device, the online status of the target PTT device, the disconnection status of the target PTT device, and the time difference between the re-registration timestamp and the disconnection timestamp; and transmitting the probability to the call-originating PTT device, wherein reception of the probability by the call-originating PTT device causes a user interface of the call-originating PTT device to display an indication of the probability.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

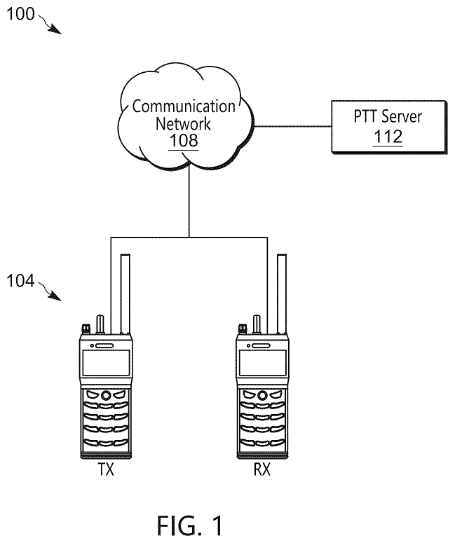

Further advantages and features consistent with this disclosure will be set forth in the following detailed description, with reference to the FIG. 30 Referring now to the drawings, FIG. 1 illustrates a radio communication system 100, according to some examples. The radio communication system 100 includes a plurality of push-to-talk (PTT) devices 104 configured to operate in the radio communication system 100. In the illustrated example, the plurality of PTT devices 104 includes a first PTT device TX and a second PTT device RX1. However, the radio communication system 100 may include more than two devices or less than two devices.

The first PTT device TX is described herein as a call-originating PTT device TX, and the second PTT device RX is described as a target PTT device RX. However, each of the plurality of PTT devices 104 may be operable to both transmit and receive radio signals over the communication network 108.

The PTT devices 104 may be operable to transmit and receive radio according to one or more suitable communication protocols. For example, the PTT devices 104 may include circuitry and/or software to operate according the Project 25(P 25 ) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, among other possibilities.

In some instances, the PTT devices 104 are configured to operate according to a mission critical push-to-talk (MCPTT) communication standard such that the communication network 108 illustrated in FIG. 1 at least includes a cellular network 108 (e.g., an LTE network). However, the communication network 108 may include additional communication networks, such as a land mobile radio (LMR) network.

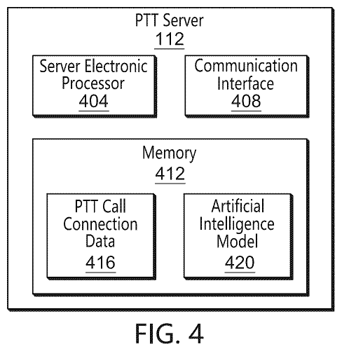

A PTT server 112, described in greater detail below with respect to FIG. 4, is communicatively connected to the PTT devices 104 over the communication network 108 (e.g., over an LMR network, a broadband network, and/or the like). The communication system 100 may include additional servers or devices communicatively connected to the PTT devices 104 over the communication network 108.

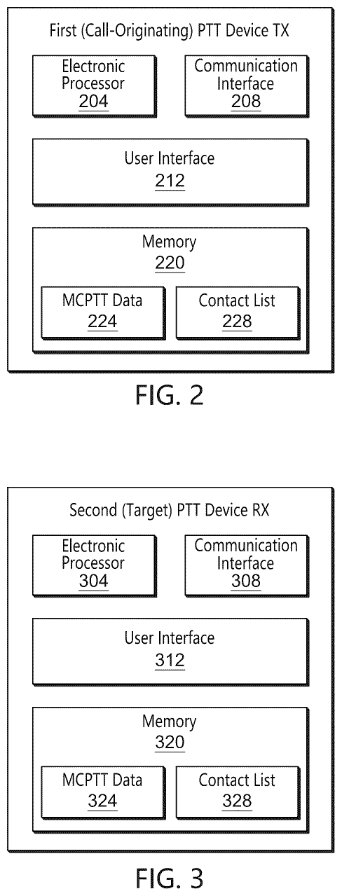

FIG. 2 schematically illustrates the first PTT device TX, according to some examples. In the example illustrated in FIG. 2, the first PTT device TX includes an electronic processor 204 communicatively connected to a communication interface 208, a user interface 212, and a memory 220. The communication interface 208 includes, for example, one or more RF transmitter/receiver systems for transmitting and receiving signals over the communication network 108 (e.g., to other radios and/or to the PTT server 112).

The user interface 212 included a microphone for converting audio (e.g., voice from a user of the first PTT device TX to electrical signals). Those signals or processed versions of them may be transmitted, using the communication interface 208, to the second PTT device RX. The user interface 212 also includes a speaker for outputting, to the user, sound data received via the communication interface 208. The user interface 212 further includes one or more buttons, knobs, dials, or the like for controlling operation of the first PTT device TX (e.g., a PTT button, a volume dial, etc.). The user interface 212 may further include a display (e.g., a touch screen display) configured to display, among other things, lists of contacts, online statuses of contacts, and/or call statuses, and receive user input to initiate calls, view statuses of selected contacts, and/or the like.

The memory 220 stores information related to operation of the first PTT device TX (e.g., MCPTT data 224) and software or program instructions that, when executed by the electronic processor 204, cause the electronic processor 204 to perform, among other things, PTT radio functions (that are described in more detail below). The memory 220 may further store a list of contacts 228 with which the first PTT device TX may initiate or receive calls.

FIG. 3 schematically illustrates the second PTT device RX, according to some examples. In the example illustrated in FIG. 3, the second PTT device RX includes an electronic processor 304 communicatively connected to a communication interface 308, a user interface 312, and a memory 320. The communication interface 308 includes, for example, one or more RF transmitter/receiver systems for transmitting and receiving signals over the communication network 108 (e.g., to other radios or devices 104 and/or to the PTT server 112).

The user interface 312 included a microphone for converting audio (e.g., voice from a user of the second PTT device RX to electrical signals). Those signals or processed versions of them may be transmitted, using the communication interface 308, to the first PTT device TX or other devices 104. The user interface 312 also includes a speaker for outputting, to the user, sound data received via the communication interface 308. The user interface 312 further includes one or more buttons, knobs, dials, or the like for controlling operation of the second PTT device RX (e.g., a PTT button, a volume dial, etc.). The user interface 312 may also include a display (e.g., a touch screen display) configured to display, among other things, lists of contacts, online statuses of contacts, and/or call statuses, and receive user input to initiate calls, view statuses of selected contacts, and/or the like.

The memory 320 stores information related to operation of the second PTT device RX (e.g., MCPTT data 324) and software or program instructions that, when executed by the electronic processor 304, cause the electronic processor 304 to perform, among other things, PTT radio functions (that are described in more detail below). The memory 320 may further store a list of contacts 328 with which the second PTT device RX may initiate or receive calls.

FIG. 4 schematically illustrates the PTT server 112, according to some examples. The PTT server 112 is, for example, a cloud-based server 112. In the example illustrated in FIG. 4, the PTT server 112 includes a server electronic processor 404 communicatively connected to a server communication interface 408, and a server memory 412. The server communication interface 408 communicatively connects the server 112 to, among other things, each of the plurality of PTT devices 104 over the communication network 108.

The server memory 412 stores information related to operation of the PTT server 112 (e.g., PTT call connection data 416) and software or program instructions that, when executed by the server electronic processor 404, cause the electronic processor 404 to perform, among other things, the methods described herein. The server memory 412 may also store an artificial intelligence (AI) model 420 for analyzing PTT call connection data and generating connectivity predictions based on the data. In some instances, the AI model 420 is a generative AI model.

The PTT server 112 may include additional components than those illustrated in FIG. 4. The PTT server 112 may perform additional functions than those described herein. In some instances, the PTT server 112 is included as part of a radio infrastructure, such as an LMR core network or other MCPTT infrastructure.

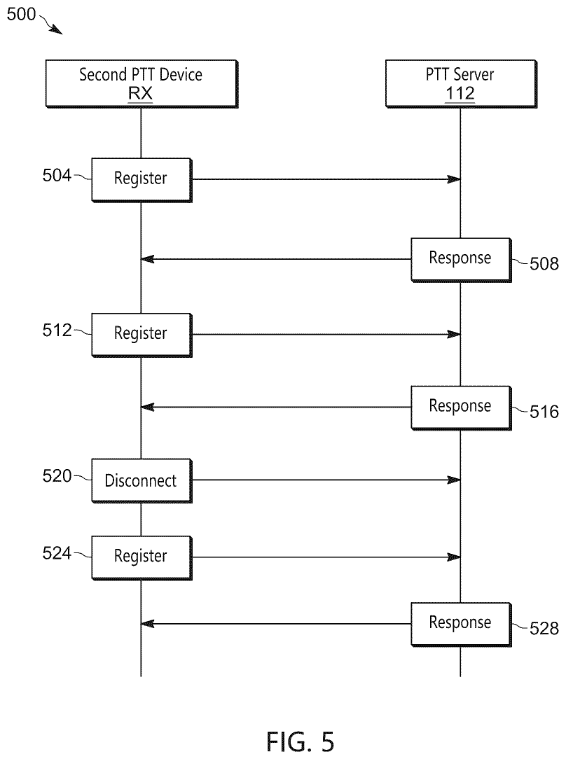

During operation according to, for example, an MCPTT protocol or other communication protocol, the plurality of PTT devices 104 may periodically register, or re-register, with the PTT server 112. For example, FIG. 5 illustrates an example communication workflow 500 between the server 112 and a PTT device, such as the second PTT device RX. The second PTT device RX transmits (e.g., using the electronic processor 304 in conjunction with the communication interface 308) a re-registration status to the PTT server 112 (at block 504). The re-registration status indicates a connection of the second PTT device RX to the communication network 108 (e.g., the LTE communication network 108 used for MCPTT operations). The re-registration status may include an identifier (ID) associated with the second PTT device RX, and may include additional parameters. For example, the second PTT device RX may also transmit a re-registration timestamp associated with the re-registration status, or the PTT server 112 may generate a re-registration timestamp in response to receiving the reregistration status. The PTT server 112 may transmit a response to the second PTT device RX acknowledging receipt of the re-registration status (at block 508).

As noted above, devices operating in the communication system 100 may periodically re-register with the PTT server 112, for example, every ten minutes, every fifteen minutes, every thirty minutes, or the like. In some instances, the devices register with the PTT server 112 in response to moving a threshold distance, in response to user interaction with the device (e.g., pressing a PTT button), or in response to another trigger condition. Accordingly, the second PTT device RX transmits a re-registration status to the server 112 (at block 512), and the server 112 transmits a response to the second PTT device RX acknowledging receipt of the re-registration status (at block 516).

The second PTT device RX may transmit a disconnection status to the server 112 indicating a disconnection of the second PTT device RX from the communication network 108 (at block 520). The disconnection status may be, for example, a real-time transport control (RTCP) goodbye packet indicating that the second PTT device RX is no longer active in a communication session. The second PTT device RX may also transmit a disconnection timestamp associated with the disconnection status, or the PTT server 112 may generate a disconnection timestamp in response to receiving the disconnection status.

After disconnection, the second PTT device RX may again register with the server 112 in response to, for example, user interaction with the second PTT device RX, movement of the second PTT device RX, or the like (at block 524), and the server 112 may transmit a response acknowledging the re-registration (at block 528).

Online statuses of contacts in PTT systems are often based solely on whether a device has registered to a network. However, as described above, network connectivity issues, delayed status updates, or inconsistencies between the reported and actual status of a user can cause inaccurate online statuses to be provided to other devices. Further, binary online/offline status indicators do not capture the nuances of a user's actual availability. For example, the first PTT device TX may display, for example as a part of a contacts list, an indication that the second PTT device RX is online when in actuality the second PTT device RX is not online. This inconsistency may lead the user of the first PTT device TX to attempt to initiate a call with the second PTT device RX, and, as a result, the call fails to connect. In mission-critical applications, such failures can hinder an emergency response.

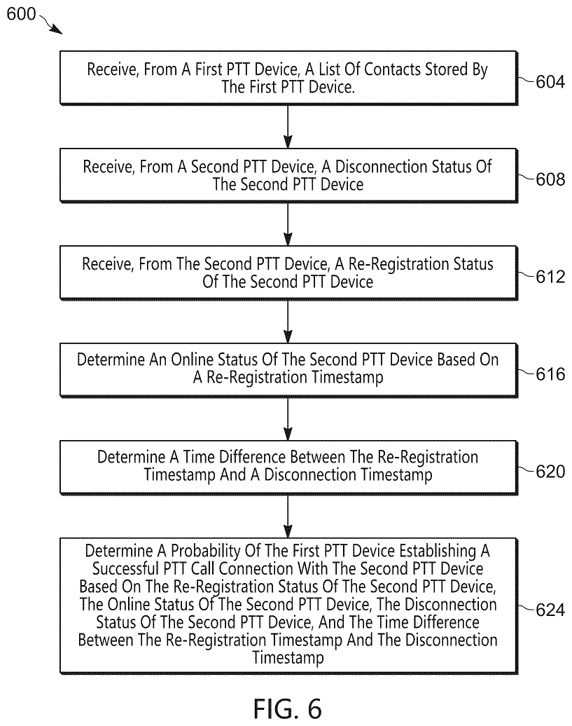

Therefore, FIG. 6 illustrates a method 600 for determining the probability of a successful PTT call connection, according to some examples. The method 600 is executed by, for example, the server electronic processor 404 of the PTT server 112 in conjunction with other components of the system 100.

The server electronic processor 404 receives, from the first PTT device TX, a list of contacts stored by the first PTT device TX (e.g., the list of contacts 228) (at block 604). The server electronic processor 404 may receive the list of contacts periodically, in response to a user of the first PTT device TX refreshing a contact list display page, in response to user of the first PTT device TX modifying the contact list, or the like. In some instances, the server electronic processor 404 does not receive the list of contacts directly from the first PTT device TX, but rather, from another server or computing device operating in the communication network 108. In the example described herein, the second PTT device RX is included in the list of contacts that is stored by the first PTT device TX and transmitted to the server 112.

The server electronic processor 404 receives, from the second PTT device RX, a disconnection status indicating a disconnection of the second PTT device RX from the communication network 108 (at block 608). The disconnection status may be substantially similar to the disconnection status described above with respect to block 520 of the communication workflow 500. The disconnection status includes a disconnection timestamp generated by the server electronic processor 404 or received directly from the second PTT device RX.

After receiving the disconnection status from the second PTT device RX, the server electronic processor 404 receives a re-registration status of the second PTT device RX with the server 112 (at block 612). The re-registration status may be substantially similar to the re-registration status described above with respect to block 524 of the communication workflow 500. For example, the re-registration status indicates a connection of the second PTT device RX to the communication network 108. The re-registration status includes a re-registration timestamp generated by the server electronic processor 404 or received directly from the second PTT device RX.

The server electronic processor 404 determines an online status of the second PTT device RX based on the re-registration timestamp (at block 616). In some instances, the online status is an initial binary online/offline status of the second PTT device RX. For example, in response to determining that the second PTT device RX has re-registered with the server 112 within a threshold period of time (e.g., fifteen minutes, thirty minutes, or the like) without transmitting a disconnection status to the server 112, the server electronic processor 404 may determine a binary status of online for the second PTT device RX. The server electronic processor 404 also determines a difference between the re-registration timestamp and the disconnection timestamp (at block 620).

The server electronic processor 404 determines a probability of the first PTT device TX establishing a successful PTT call connection with the second PTT device based on the re-registration status of the second PTT device, the online status of the second PTT device, the disconnection status of the second PTT device, and the time difference between the re-registration timestamp and the disconnection timestamp (at block 624). In some instances, the server electronic processor 404 determines the probability according to a logistical regression algorithm model using a sigmoid function. For example, the server electronic processor 404 tallies the reported re-registrations and disconnections of the second PTT device RX, and performs a maximum likelihood estimation with respect to a set of parameters defined by the re-registration status of the second PTT device, the online status of the second PTT device, the disconnection status of the second PTT device, and the time difference between the re-registration timestamp and the disconnection timestamp in order to determine the probability that a call connection to the second PTT device will be successful.

In some instances, the server electronic processor 404 trains a machine learning model (e.g., the AI model 420) using historical data sets of the set of parameters described above for the second PTT device RX, such that the probability of successful call connection corresponds to a confidence level output by the machine learning model. The historical data may be collected by the server 112 over the course of a week, a month, a year, or the like.

In some instances, the machine learning model is a generative AI model that outputs the confidence level based on the maximum likelihood estimation of the logistical regression model. In a communication system having a large number of PTT devices 104 operating therein, the use of a generative AI model rather than a conventional predictive AI model enables the server 112 to process the large volumes of connectivity data associated with each of the PTT devices 104 and timely generate call connection predictions for the PTT devices 104.

The server electronic processor 404 may transmit the probability to the first PTT device TX periodically (e.g., every 5 minutes, every ten minutes, every 30 minutes, etc.) and/or in response to a trigger. For example, the server electronic processor 404 may transmit the probability to the first PTT device TX in response to receiving a request from the first PTT device TX (e.g., in response to a user of the first PTT device TX refreshing a contacts page). The server electronic processor 404 may transmit the probability in response to receiving an indication that the first PTT device has initiated a call with the second PTT device RX. The server electronic processor 404 may transmit the probability to the first PTT device TX in response to detecting a change in the online status and/or probability associated with the second PTT device RX.

The server electronic processor 404 may perform some or all of the steps of the method 600 for the respective PTT device corresponding to each contact in the list of contacts 228 received from the first PTT device TX. For example, for each respective contact included in the list of contacts 228, the server electronic processor 404 may determine a respective probability of establishing a successful PTT call connection from the first PTT device TX to the respective contact based on a re-registration status of the respective contact, an online status of the respective contact, a disconnection status of the respective contact, and a time difference between a disconnection timestamp and re-registration timestamp of the respective contact. For each respective contact included in the list of contacts 228, the server electronic processor 404 transmits the respective probability to the first PTT device TX.

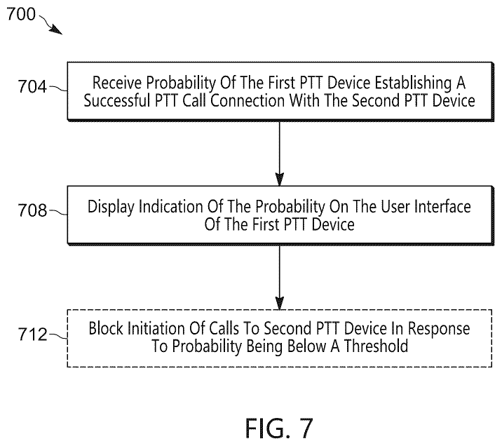

Reception of the transmitted probability by the first PTT device TX causes the user interface 212 of the first PTT device RX to display an indication of the probability. For example, FIG. 7 illustrates a method 700 for displaying a probability of a successful push-to-talk call connection, according to some examples. The method 700 is executed by, for example, the PTT device electronic processor 204 of the first (e.g., the call-originating) PTT device TX. The device electronic processor 204 receives, from the PTT server 112, the probability of the first PTT device establishing a successful PTT call connection with the second (e.g., target) PTT device RX (at block 704). In some instances, in addition to the probability, the device electronic processor 204 receives the binary online status of the second PTT device RX.

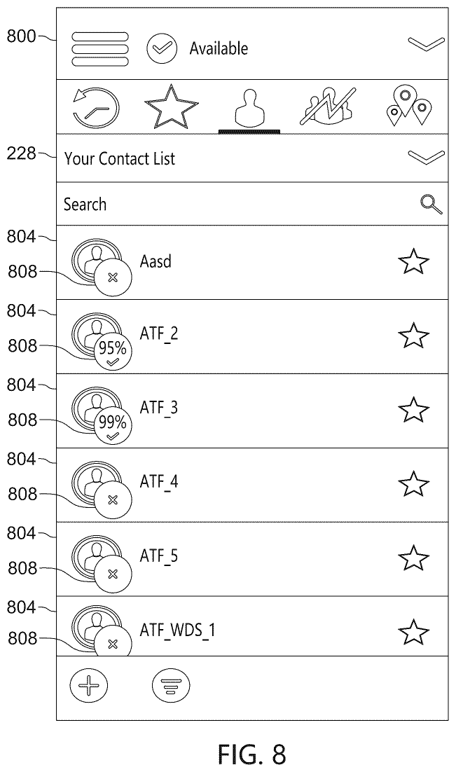

In response to receiving the probability, the device electronic processor 204 displays an indication of the probability on the user interface 212 of the first PTT device TX (at block 708). FIG. 8 illustrates an example illustrates an example graphical user interface (GUI) 800 (e.g., a contacts page 800) that the device electronic processor 204 displays on the user interface 212 to indicate the probability. As illustrated in FIG. 8, the contacts page 800 displayed on the user interface 212 includes the list of contacts 228 stored in the device memory 220, with each contact in the list of contacts 228 having a corresponding contact card 804.

In the illustrated example, each contact card 804 includes a status icon 808 including an online status indicator of the corresponding contact. In the example of FIG. 8, an online status is represented by a check mark and an offline status is represented by an X mark. However, other symbols or indicators, such as color indicators, are contemplated. For example, rather than displaying a symbol (e.g., a check mark or an X mark), the device electronic processor 204 may display a color-coded ring around a contact photo in the contact card 804 indicating the online status of the contact.

In instances where a corresponding contact is online (e.g., indicated with a check mark), the device electronic processor 204 displays, on the user interface 212, the indication of the corresponding probability adjacent to the online status indicator. In the illustrated example, the corresponding probability is represented as a percentage. For example, the contact card 804 labeled “ATF_2” is indicated as online and having a 95% probability of successful connection.

The contact card 804 labeled “ATF_3” is indicated as online and having a 99% probability of successful call connection. In this manner, a user of the first PTT device TX is able to make a decision of which contact to attempt to initiate a call with when, for example, responding to an emergency situation.

While displayed as percentages in FIG. 8, the probability indicator may alternatively be displayed in another form, such as a number between 1 and 10, as a color-coded indicator, or the like.

In some instances, in response to the online status of the second PTT device RX (e.g., as received from the server 112) indicating that the second PTT device is not online, the device electronic processor 204 of the first PTT device TX does not display or refrains from displaying the indication of probability on the user interface 212. For example, as illustrated in FIG. 8, the contact card 804 labeled “ATF_4” does not include an indication of the probability.

While FIG. 8 illustrates each contact card 804 as having a corresponding status icon 808, in some instances, no status information is available (e.g., no status information is received from the server 112). In such instances, the device electronic processor 204 may not display an empty status icon 808 (e.g., without a check mark or an X mark), may not display any status icon 808, or may display a default status indicator (e.g., default X mark).

In some instances, in response to determining that the probability of a successful call connection with the second PTT device RX is below a threshold (e.g., less than 90%, less than 90%, less than 65%, etc.), the device electronic processor 204 temporarily blocks initiation of a PTT call to the second PTT device RX (at block 712). Temporarily blocking initiation of the call may include disabling selection of the contact card 804 corresponding to the second PTT device RX. Alternatively or in addition, temporarily blocking initiation of the call may include generating and displaying a warning on the user interface 212 that the call connection probability is below the threshold. In some instances, the server electronic processor 404 transmits, to the first PTT device TX, the command to temporarily block initiation of the PTT call in response to the probability being below the threshold.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot register to push-to-talk communication networks, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as

meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A server configured to communicatively connect to a plurality of push-to-talk (PTT) devices that communicate with one another over a communication network, the server comprising:
an electronic processor configured to
receive, from a first PTT device, a list of contacts stored by a first PTT device,
receive, from a second PTT device that is included in the list of contacts stored by the first PTT device, a disconnection status of the second PTT device, the disconnection status indicating a disconnection of the second PTT device from the communication network and including a disconnection timestamp,
receive, from the second PTT device after receiving the disconnection status, a re-registration status of the second PTT device with the server, wherein the re-registration status indicates a connection of the second PTT device to the communication network and includes a re-registration timestamp,
determine an online status of the second PTT device based on the re-registration timestamp,
determine a time difference between the re-registration timestamp and the disconnection timestamp,
determine a probability of the first PTT device establishing a successful PTT call connection with the second PTT device based on the re-registration status of the second PTT device, the online status of the second PTT device, the disconnection status of the second PTT device, and the time difference between the re-registration timestamp and the disconnection timestamp, and
transmit the probability to the first PTT device, wherein reception of the probability by the first PTT device causes a user interface of the first PTT device to display an indication of the probability.

2. The server of claim 1, wherein the electronic processor is configured to transmit the probability to the first PTT device in response to receiving an indication that the first PTT device has initiated a PTT call to the second PTT device.

3. The server of claim 1, wherein the electronic processor periodically transmits the probability to the first PTT device.

4. The server of claim 1, wherein the electronic processor transmits the probability to the first PTT device in response to receiving a request from the first PTT device.

5. The server of claim 1, wherein the electronic processor is configured to determine the probability according to a logistical regression algorithm model using a sigmoid function.

6. The server of claim 5, wherein the electronic processor is further configured to:
train a machine learning model using historical data sets corresponding to re-registration statuses, online statuses, disconnection statuses, and time differences for the second PTT device,
wherein the probability corresponds to a confidence level output by the machine learning model.

7. The server of claim 6, wherein the machine learning model is a generative AI model that outputs the confidence level based on a maximum likelihood estimation of the logistical regression algorithm model.

8. The server of claim 7, wherein the historical data sets include a tally of re-registrations and disconnections of the second PTT device.

9. The server of claim 1, wherein the electronic processor is further configured to, for each respective contact included in the list of contacts:
determine a respective probability of establishing a successful PTT call connection from the first PTT device to the respective contact based on a re-registration status of the respective contact, an online status of the respective contact, a disconnection status of the respective contact, and a time difference between a disconnection timestamp and re-registration timestamp of the respective contact, and
transmit the respective probability to the first PTT device.

10. The server of claim 1, wherein the electronic processor is further configured to
in response to the probability being below a threshold, transmit a command to the first PTT device to temporarily block initiation of a PTT call to the second PTT device by the first PTT device.

11. The server of claim 1, wherein the plurality of PTT devices is a plurality of mission critical PTT (MCPTT) devices and the communication network is a MCPTT network.

12. A push-to-talk (PTT) system comprising:
a first PTT device including a user interface, a memory storing a list of contacts, and a device electronic processor; and
a server including a server electronic processor configured to
receive, from a second PTT device that is included in the list of contacts, a disconnection status of the second PTT device, the disconnection status indicating a disconnection of the second PTT device from a communication network and including a disconnection timestamp,
receive, from the second PTT device, a re-registration status of the second PTT device with the server, wherein the re-registration status indicates a connection of the second PTT device to the communication network and includes a re-registration timestamp,
determine an online status of the second PTT device based on the re-registration timestamp,
determine a time difference between the re-registration timestamp and the disconnection timestamp,
determine a probability of the first PTT device establishing a successful PTT call connection with the second PTT device based on the re-registration status of the second PTT device, the online status of the second PTT device, the disconnection status of the second PTT device, and the time difference between the re-registration timestamp and the disconnection timestamp, and
transmit the probability to the first PTT device;
wherein the device electronic processor is configured to
in response to receiving the probability, display an indication of the probability on the user interface.

13. The system of claim 12, wherein the device electronic processor is further configured to
display, on the user interface, an indication of the online status of the second PTT device adjacent to the indication of the probability.

14. The system of claim 12, wherein the device electronic processor is configured to display the indication of the probability as a percentage.

15. The system of claim 12, wherein the device electronic processor is further configured to
receive the online status of the second PTT device, and
in response to the online status of the second PTT device indicating that the second PTT device is not online, refrain from displaying the indication of probability.

16. The system of claim 12, wherein the device electronic processor is further configured to
in response to determining that the probability is below a threshold, temporarily block initiation of a PTT call to the second PTT device.

17. The system of claim 12, wherein the server electronic processor is configured to determine the probability according to a logistical regression algorithm model using a sigmoid function.

18. The system of claim 17, wherein the server electronic processor is further configured to:
train a machine learning model using historical data sets corresponding to re-registration statuses, online statuses, disconnection statuses, and time differences for the second PTT device,
wherein the probability corresponds to a confidence level output by the machine learning model.

19. The system of claim 18, wherein the machine learning model is a generative AI model that outputs the confidence level based on a maximum likelihood estimation of the logistical regression algorithm model.

20. A method for determining a probability of successful establishment of a push-to-talk (PTT) call connection between a call-originating PTT device and a target PTT device, the method comprising:
receiving, from the call-originating PTT device, a list of contacts stored by the call-originating PTT device;
receiving, from the target PTT device that is included in the list of contacts stored by the call-originating PTT device, a disconnection status of the target PTT device, the disconnection status indicating a disconnection of the target PTT device from a communication network and including a disconnection timestamp;
receiving, from the target PTT device after receiving the disconnection status, a re-registration status of the target PTT device, wherein the re-registration status indicates a connection of the target PTT device to the communication network and includes a re-registration timestamp;
determining an online status of the target PTT device based on the re-registration timestamp;
determining a time difference between the re-registration timestamp and the disconnection timestamp;
determining a probability of the call-originating PTT device establishing a successful PTT call connection with the target PTT device based on the re-registration status of the target PTT device, the online status of the target PTT device, the disconnection status of the target PTT device, and the time difference between the re-registration timestamp and the disconnection timestamp; and
transmitting the probability to the call-originating PTT device, wherein reception of the probability by the call-originating PTT device causes a user interface of the call-originating PTT device to display an indication of the probability.
